(19) United States
(12) Patent Application Publication
(10) Pub. No.: US 2007/0270049 A1
(43) Pub. Date: Nov. 22, 2007

(54) Method for forming electrical contacts on an electrical connector

(75) Inventors: Feng-Chien Hsu, Taipei Hsien (TW); An-Chyi Liou, Taipei Hsien (TW)

Correspondence Address: COOPER & DUNHAM, LLP, 1185 AVENUE OF THE AMERICAS, NEW YORK, NY, 10036, US

(73) Assignee: Suyin Corporation

(21) Appl. No.: 11/437,054

(22) Filed: May 19, 2006

(51) Int. Cl. H01R 4/02

(52) U.S. Cl. 439/876

(57) ABSTRACT

A method for forming electrical contacts on an electrical connector having terminals therein includes the steps of preparing a screening board on top of the electrical connector to allow each mesh to align with a center of a top face of each of the terminals of the electrical connector, the screening board having meshes defined therein. Tin paste is applied onto the screening board to allow the tin paste to fill in each of the meshes. Excessive tin paste is removed from the screen board. Then the screening board is removed to leave tin blocks on the centers of the top faces of the terminals of the electrical connector. A heating step is processed to heat the electrical connector. Then electrical contacts are formed on the top faces of the terminals of the electrical connector.

### BACKGROUND OF THE INVENTION

1. Field of the Invention

The present invention relates to a method for forming electrical contacts, and more particularly to a method for forming electrical contacts for terminals on a an electrical connector.

2. Description of the Prior Art

With reference to FIGS. 6 and 7, it is noted that the conventional electrical connector is composed of a base (50) and a cover (51) slidably mounted on top of the base (50). Both of the base (50) and the cover (51) are provided with multiple mutually aligned holes (52) respectively receiving therein a terminal (53). The terminal (53) has a connecting end (531) designated to engage with one of legs of an integrated circuit (not shown) and an engaging end (532) designated to clamp the integrated circuit legs. A solder ball (60) is provided on a top face (533) of each of the terminals (53) so that an electrical connection the integrated circuit, the electrical connector and the circuit board on the bottom of the electrical connector is established.

It is also known that there are two phases for forming the solder balls (60) on the top faces (533) of the terminals (53), i.e. pre-phase and post-phase.

In the Pre-phase stage:

A layer of soldering enhanced agent (54) is first applied to the top faces (533) of the terminals (53). Then the pre-formed solder ball (60) is moved on top of and engaged with the soldering enhanced agent (54).

In the post-phase stage:

The terminals (53) with the solder balls (60) provided respectively on the top faces (533) of the terminals (53) are heated to vaporize the soldering enhanced agent (54) so that each of the solder balls (60) is supposed to be positioned at the center of each of the top faces (533) of the terminals (53) to complete the electrical connection for future use.

With reference to FIGS. 8 and 9, a different conventional electrical connector is shown and has a base (70) and multiple holes (71) to respectively receive therein a terminal (72). Each terminal (72) is provided with a connecting end (not shown) and an engaging end (721) with a solder ball (80) formed on a top face (7211) of the engaging end (721) so as to form an electrical connection among the electrical connector, an electrical appliance received in the electrical connector and a circuit board beneath the electrical connector. In either case, the method for forming the solder ball (60, 80) is the same so that disregard the structure of the electrical connectors in either cases, both structures suffer from the following common shortcomings.

1. Each of the solder balls (60,80) is previously formed via cooling molten tin blocks after passing through a mesh such that the cost for manufacturing the miniaturized solder balls (60,80) is high. In addition, due to the material quality and technique used to produce the solder balls (60,80), dimension of the solder balls (60,80) varies and each solder ball (60,80) might not be spherical.

2. During the soldering enhanced agent vaporization step, as a result of heating the terminals (53,72), the solder balls (60,80) descend to the center of the top faces (533,7211) of the connecting ends (531,721) of the terminals (53,72). However, during the heating process, vibration from the heating mechanism deviates the location of the solder balls (60,80). Therefore, the solder balls (60,80) supposed to locate at the center of the top faces (533,7211) of the connecting ends (531,721) of the terminals (53,72) are located elsewhere. That is, most of the solder balls (60,80) are not able to exactly located at the center of the top faces (533,7211) of the connecting ends (531,721) of the terminals (53,72). Therefore, the electrical connection between the electrical connector and the circuit board is defected and thus signal transmission therebetween is ineffective.

To overcome the shortcomings, the present invention tends to provide an improved method for forming solder balls to mitigate the aforementioned problems.

### SUMMARY OF THE INVENTION

The primary objective of the present invention is to provide a method for forming solder balls to effectively establish an electrical connection with other electrical appliances.

In order to accomplish the aforementioned objective, the method of the present invention includes the steps of:

preparing a screening board having meshes defined therein and each mesh being conical, the screening board being placed on top of an electrical connector to allow each mesh to align with a center of a top face of each of the terminals of the electrical connector;

applying tin paste onto the screening board to allow the tin paste to fill in each of the meshes;

removing excessive tin paste from the screening board;

removing the screening board to leave tin blocks on the center of the top faces of the terminals of the electrical connector;

heating a base of the electrical connector; and

forming electrical contacts on the top faces of the terminals of the electrical connector.

Other objects, advantages and novel features of the invention will become more apparent from the following detailed description when taken in conjunction with the accompanying drawings.

### BRIEF DESCRIPTION OF THE DRAWINGS

FIG. 1 is a flow chart of the method of the present invention;

FIG. 2 is a schematic view showing that the tin paste is applied onto the screening board;

FIG. 3 is a schematic view showing that excessive tin paste is removed from the screening board by a scraper;

FIG. 4 is a schematic view showing that the screening board is being removed;

FIG. 5 is a schematic view showing that electrical contacts are formed on top of the electrical connector;

FIG. 6 is a perspective view showing a conventional electrical connector;

FIG. 7 is a schematic cross sectional view showing the internal structure of the conventional electrical connector in FIG. 6;

FIG. 8 is a perspective view showing a different electrical connector; and

FIG. 9 is a partially perspective view showing details of the electrical connector in FIG. 8.

### DETAILED DESCRIPTION OF THE PREFERRED EMBODIMENT

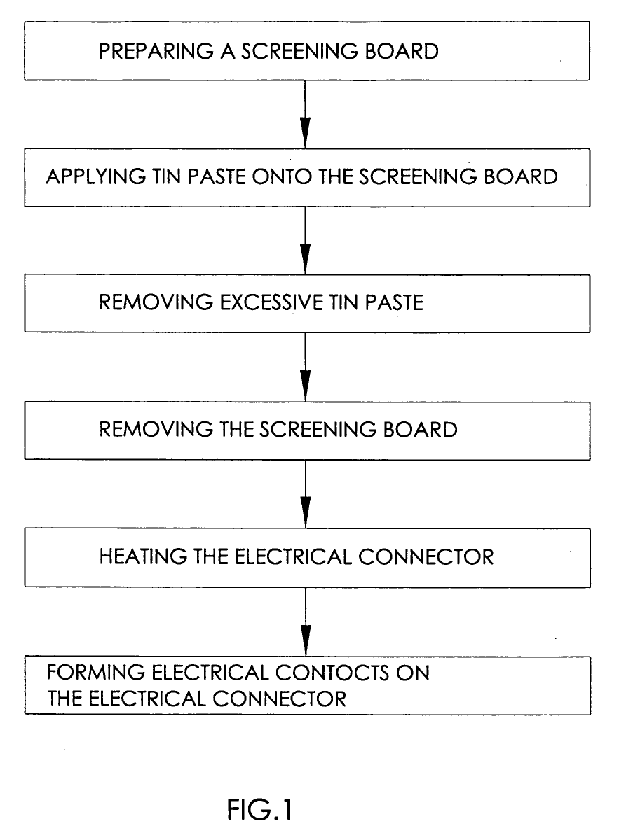

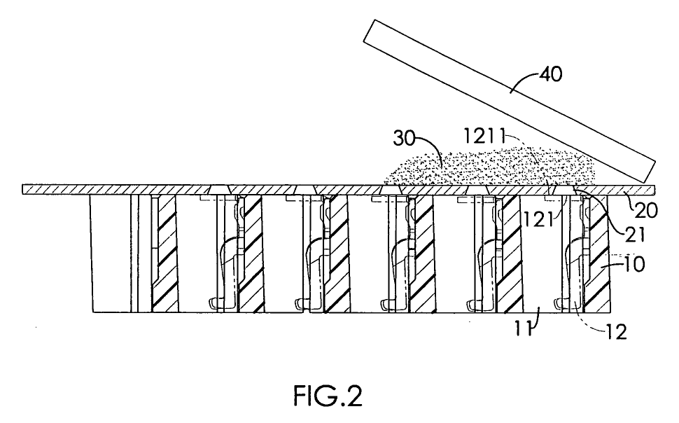

With reference to FIGS. 1 and 2, it is noted that the electrical contact forming method in accordance with the present invention includes the steps of:

preparing a screening board (20) having meshes (21) defined therein and each mesh being conical, the screening board (20) being placed on top of an electrical connector (10) to allow each mesh (21) to align with a center of a top face (1211) of each of connecting ends (121) of each of terminals (12) respectively received in a through hole (11) defined in the electrical connector (10);

applying tin paste (30) onto the screening board (20) to allow the tin paste (30) to fill in each of the meshes (21), as shown in FIG. 2;

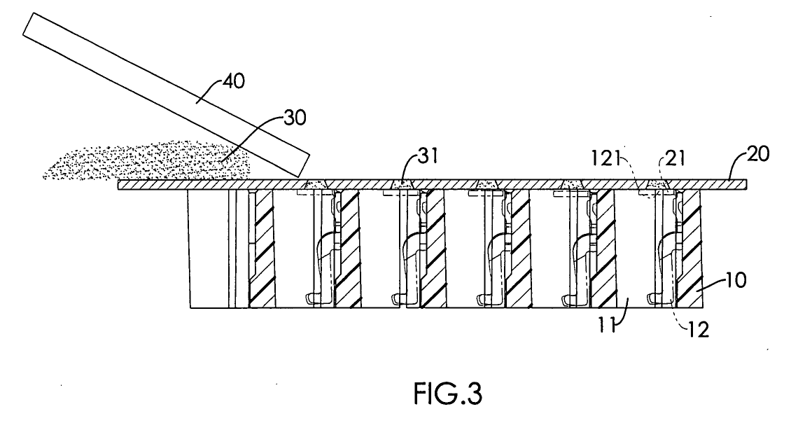

removing excessive tin paste (30) from the screening board (20), as shown in FIG. 3;

After the excessive tin paste (30) is removed from the screening board (20) via such as a scraper (40), it is noted that a tin blocks (31) is filled in each and everyone of the meshes (21). Because of the conical configuration of the meshes (21), the tin blocks (31) on top of the electrical connector (10) are also conical.

removing the screening board (20) to leave tin blocks (31) on the center of the top faces (1211) of the terminals (12) of the electrical connector (10);

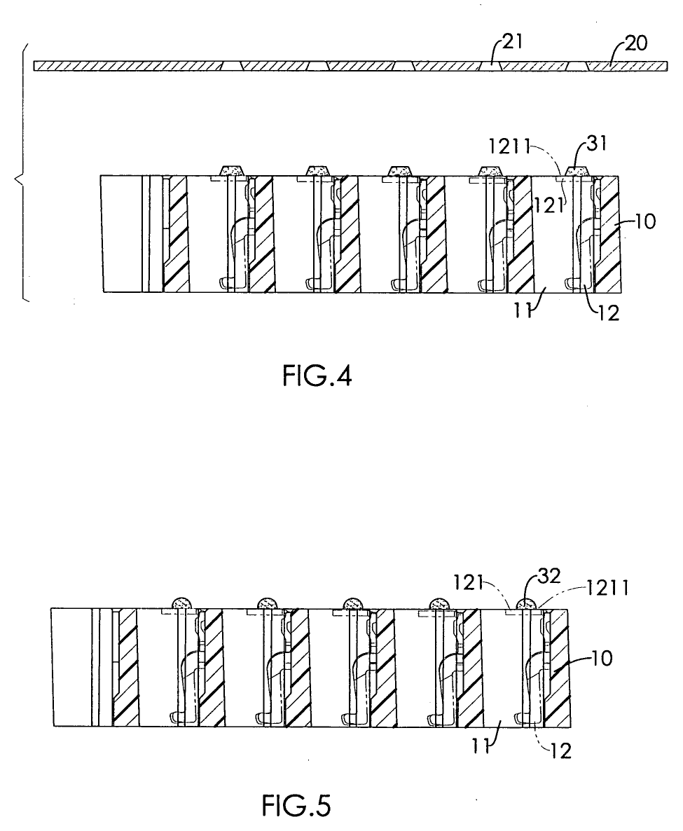

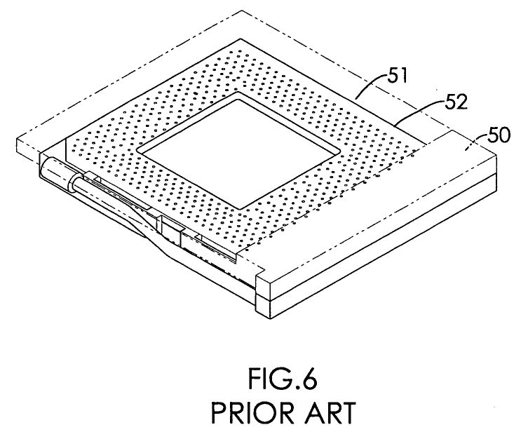

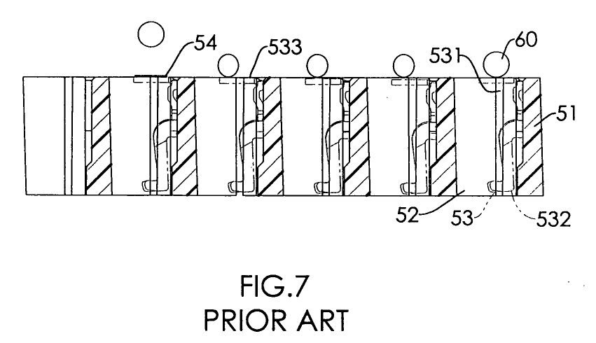

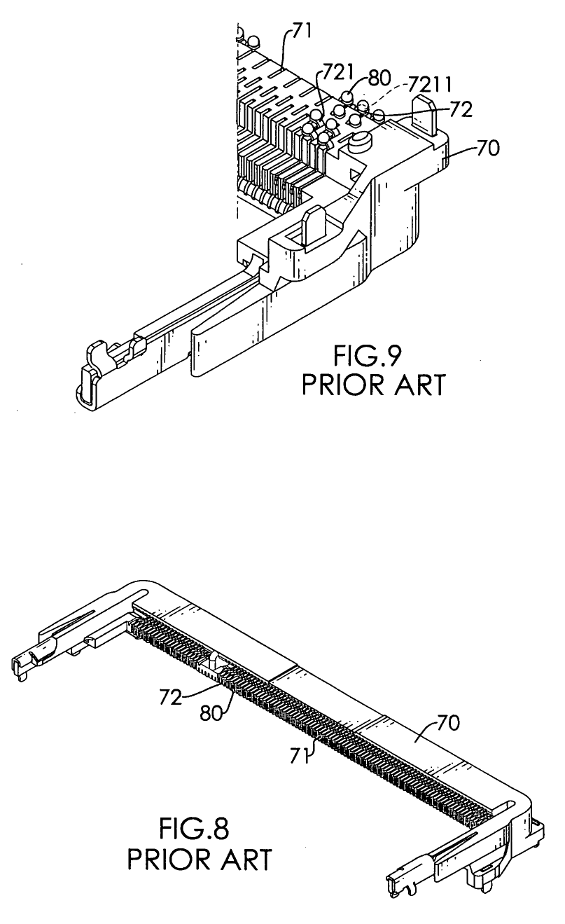

Again, due to the conical configuration of the meshes (21), removal of the screening board (20), as shown in FIG. 4, is easy.

heating a base of the electrical connector (10);

Via far-infrared heating or any appropriate heating methods known in the art, the tin blocks (31) are heated first and then the tin blocks (31) have a spherical appearance due to internal converging force in process of cooling.

forming electrical contacts (32) on the top faces (1211) of the terminals (12) of the electrical connector (10).

From the aforementioned description, it is noted that when the screening board (20) is placed on top of the electrical connector (10), each mesh (21) of the screening board (20) is aligned with the center of the top face (1211) of the terminals (12) so that when the tin blocks (31) are formed on the electrical connector (10), the electrical contacts (32) are perfectly located on the centers of the top faces (1211) of the terminals (12) of the electrical connector (10).

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A method for forming electrical contacts on an electrical connector having terminals, the method comprising the steps of:
preparing a screening board on top of the electrical connector to allow each mesh to align with a center of a top face of each of the terminals of the electrical connector, the screening board having meshes defined therein;
applying tin paste onto the screening board to allow the tin paste to fill in each of the meshes;
removing excessive tin paste from the screening board;
removing the screeni board to leave tin blocks on the centers of the top faces of the terminals of the electrical connector;
heating the electrical connector; and
forming electrical contacts on the top faces of the terminals of the electrical connector.

2. The method as claimed in claim 1, wherein the meshes are conical.

3. The method as claimed in claim 1, wherein the excessive tin paste is removed via a scraper.

4. The method as claimed in claim 2, wherein the excessive tin paste is removed via a scraper.

5. The method as claimed in claim 4, wherein the tin blocks are conical.

6. The method as claimed in claim 4, wherein a far-infrared heating is selected to proceed the heating step.

7. The method as claimed in claim 5, wherein a far-infrared heating is selected to proceed the heating step.

8. The method as claimed in claim 6, wherein the electrical contacts are spherical.

9. The method as claimed in claim 7, wherein the electrical contacts are spherical.
